(19) United States
(12) Patent Application Publication
(10) Pub. No.: US 2023/0412354 A1
(43) Pub. Date: Dec. 21, 2023

(54) 100BASE-TX TRANSCEIVER WITH TRANSMIT CLOCK IN SYNC WITH RECEIVE CLOCK FOR NOISE REDUCTION AND ASSOCIATED METHOD

(71) Applicant: Airoha Technology Corp., Hsinchu City (TW)

(72) Inventors: Chia-Hsing Hsu, New Taipei City (TW); Chun-Chia Huang, Hsinchu City (TW)

(73) Assignee: Airoha Technology Corp., Hsinchu City (TW)

(21) Appl. No.: 17/980,566

(22) Filed: Nov. 4, 2022

Related U.S. Application Data
(60) Provisional application No. 63/346,906, filed on May 30, 2022.

(51) Int. Cl. H04L 7/00

(52) U.S. Cl. CPC H04L 7/0025; H04L 7/0008; H04L 7/0029

(57) ABSTRACT

A 100BASE-TX transceiver includes a receive (RX) circuit, a transmit (TX) circuit, and a noise reduction circuit. The RX circuit receives an input data according to an RX clock, to generate an RX data. The TX circuit transmits a TX data according to a TX clock, to generate an output data, wherein the TX clock is constrained to be in sync with the RX clock. The noise reduction circuit applies noise reduction to the RX data according to the TX data, to generate a noise-reduced RX data.

### CROSS REFERENCE TO RELATED APPLICATIONS

This application claims the benefit of U.S. Provisional Application No. 63/346,906, filed on May 30, 2022. The content of the application is incorporated herein by reference.

### BACKGROUND OF THE INVENTION

### 1. Field of the Invention

The present invention relates to 100BASE-TX networking, and more particularly, to a 100BASE-TX transceiver with a transmit (TX) clock in sync with a receive (RX) clock for noise reduction (e.g., near-end crosstalk cancellation) and an associated method.

### 2. Description of the Prior Art

100BASE-TX is the technical name of Fast Ethernet over twisted pair cables. It was launched as the Institute of Electrical and Electronics Engineers (IEEE) 802.3u standard in 1995. Specifically, 100BASE-TX is a Fast Ethernet standard for local area networks (LANs), where “100” refers to a maximum transmission speed of 100 Mbps, “BASE” refers to baseband signaling, “T” refers to twisted as in twisted-pair cabling, and “TX” shows that the application is utilizing CAT5 cables, where two pairs of copper wires are being used to support the transmission speed of 100 Mbps. In a case where a Medium Dependent Interface (MDI) signal is output from a 100BASE-TX transmitter and transmitted via a cable with a length longer than 100 M, a repeater is typically needed to be installed between two network devices to extend the transmission distance, which increases the installation cost and the installation difficulty.

Furthermore, in accordance with the IEEE 802.3u-1995 standard, there is no clock synchronization scheme (e.g., master-slave clocking architecture) specified for a transmit (TX) clock used by the 100BASE-TX transmitter and a receive (RX) clock used by the 100BASE-TX receiver. Since the TX clock and the RX clock do not have the same frequency, the transmitter induced near-end crosstalk can't be cancelled under such circumstance. Regarding the long-distance transmission, near-end crosstalk will deteriorate link's signal-to-noise ratio (SNR) and become a critical bottleneck to extend the transmission distance.

Thus, there is a need for an innovative 100BASE-TX transceiver design which is capable of cancelling or mitigating the near-end crosstalk for extending the transmission distance without the need of repeaters.

### SUMMARY OF THE INVENTION

One of the objectives of the claimed invention is to provide a 100BASE-TX transceiver with a transmit (TX) clock in sync with a receive (RX) clock for noise reduction (e.g., near-end crosstalk cancellation) and an associated method.

According to a first aspect of the present invention, an exemplary 100BASE-TX transceiver is disclosed. The exemplary 100BASE-TX transceiver includes a receive (RX) circuit, a transmit (TX) circuit, and a noise reduction circuit. The RX circuit is arranged to receive an input data according to an RX clock, to generate an RX data. The TX circuit is arranged to transmit a TX data according to a TX clock, to generate an output data, wherein the TX clock is constrained to be in sync with the RX clock. The noise reduction circuit is arranged to apply noise reduction to the RX data according to the TX data, to generate a noise-reduced RX data.

According to a second aspect of the present invention, an exemplary 100BASE-TX transceiving method is disclosed. The exemplary 100BASE-TX transceiving method includes: receiving an input data according to a receive (RX) clock, to generate an RX data; transmitting a transmit (TX) data according to a TX clock, to generate an output data, wherein the TX clock is constrained to be in sync with the RX clock; and applying noise reduction to the RX data according to the TX data, to generate a noise-reduced RX data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a 100BASE-TX transceiver according to an embodiment of the present invention.

FIG. 2 is a diagram illustrating one implementation of a 100BASE-TX transceiver according to an embodiment of the present invention.

FIG. 3 is a flowchart illustrating a 100BASE-TX transceiving method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

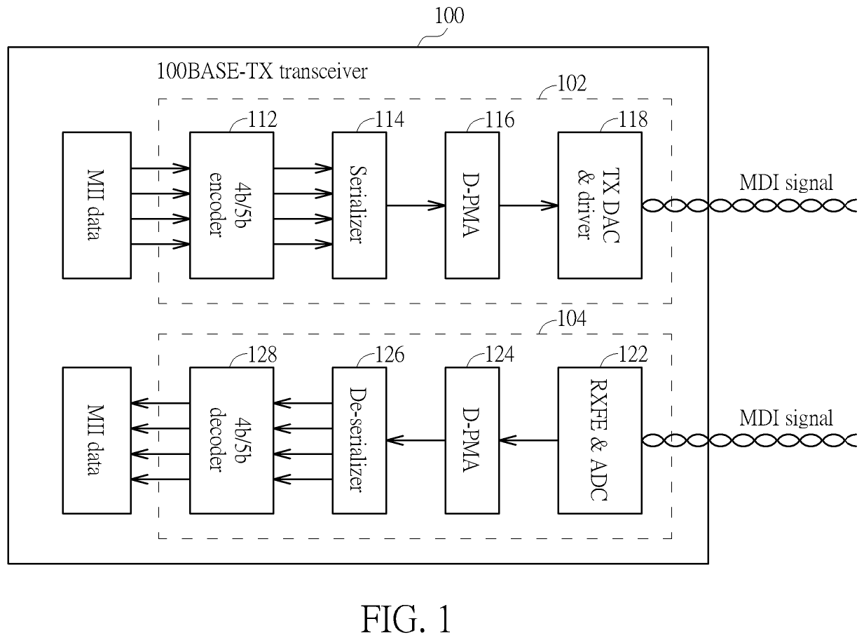

FIG. 1 is a diagram illustrating a 100BASE-TX transceiver according to an embodiment of the present invention. The 100BASE-TX transceiver 100 may be regarded as a combination of a 100BASE-TX transmitter 102 and a 100BASE-TX receiver 104. The 100BASE-TX transmitter 102 includes a 4b/5b encoder circuit (labeled by “4b/5b encoder”) 112, a serializer circuit (labeled by “serializer”) 114, a digital front-end circuit (labeled by “D-PMA”, D-PMA is the abbreviation of Digital part of Physical Medium Attachment unit) 116, and a transmit (TX) digital-to-analog converter (DAC) and driver circuit (labeled by “TX DAC & driver”) 118. The 100BASE-TX receiver 104 includes an RX front-end and analog-to-digital converter (ADC) circuit (labeled by “RXFE & ADC”) 122, a digital front-end circuit (labeled by “D-PMA”) 124, a de-serializer circuit (labeled by “De-serializer”) 126, and a 4b/5b decoder circuit (labeled by “4b/5b decoder”) 128. It should be noted that only the components pertinent to the present invention are shown in FIG. 1. In practice, the 100BASE-TX transmitter 102 may include additional components to achieve other functions, and/or the 100BASE-TX receiver 104 may include additional components to the achieve other functions.

The 100BASE-TX transmitter 102 receives medium independent interface (MII) data from a media access control (MAC) layer, and transmits a medium dependent interface (MDI) signal via a twisted-pair cable. The 100BASE-TX receiver 104 receives an MDI signal from a twisted-pair cable, and outputs MII data to the MAC layer. The major difference between the proposed 100BASE-TX transceiver 100 and a typical 100BASE-TX transceiver is that the digital front-end circuit 124 is configured to support a noise reduction function (e.g., near-end crosstalk cancellation function) due to a TX clock being constrained to be in sync with an RX clock. Since the present invention is focused on the innovative noise reduction design implemented in the 100BASE-TX transceiver 100, further description of fundamental principles of the 100BASE-TX transmitter 102 and the 100BASE-TX receiver 104 is omitted here for brevity.

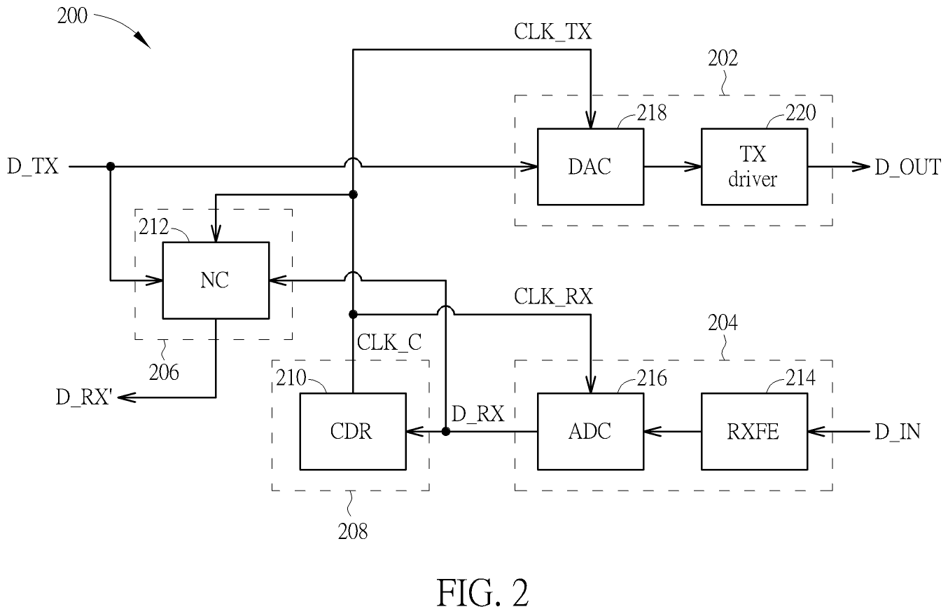

FIG. 2 is a diagram illustrating one implementation of a 100BASE-TX transceiver according to an embodiment of the present invention. It should be noted that only the components pertinent to the present invention are illustrated. For example, a part of the 100BASE-TX transceiver 100 in FIG. 1 may be implemented by the 100BASE-TX transceiver 200 shown in FIG. 2. The 100BASE-TX transceiver 200 includes a TX circuit 202, an RX circuit 204, a noise reduction circuit 206, and a clock generator circuit 208. The RX circuit 204 is arranged to receive an input data D_IN according to an RX clock CLK_RX, to generate an RX data D_RX. For example, the input data D_IN may be an MDI signal received from a twisted-pair cable. The TX circuit 202 is arranged to transmit a TX data D_TX according to a TX clock CLK_TX, to generate an output data D_OUT. For example, the TX data D_TX may be an output of the serializer circuit 114 shown in FIG. 1, and the output data D_OUT may be an MDI signal transmitted via a twisted-pair cable. In this embodiment, the TX clock CLK_TX is intentionally constrained to be in sync with the RX clock CLK_RX. Since the TX clock CLK_TX and the RX clock CLK_RX have the same frequency and phase, noise reduction can be realized. Compared to a typical 100BASE-TX transceiver without noise reduction, the 100BASE-TX transceiver 200 with noise reduction allows long-distance transmission in the absence of repeaters. Specifically, the noise reduction circuit 206 is arranged to apply noise reduction to the RX data D_RX according to the TX data D_TX, to generate a noise-reduced RX data D_RX′. For example, the noise-reduced RX data D_RX′ may act as an input of the de-serializer circuit 126 shown in FIG. 1.

As mentioned above, the TX clock CLK_TX is intentionally constrained to be in sync with the RX clock CLK_RX. In this embodiment, the clock generator circuit 208 is arranged to generate a common clock CLK_C, wherein both of the RX clock CLK_RX and the TX clock CLK_TX are set by the same common clock CLK_C. Since both of the RX clock CLK_RX and the TX clock CLK_TX are set by the same common clock CLK_C, the TX clock CLK_TX is ensured to be in sync with the RX clock CLK_RX, which allows noise reduction at the noise reduction circuit 206. For example, the clock generator circuit 208 may be implemented by a clock and data recovery (CDR) circuit (labeled by “CDR”) 210 that is arranged to generate an RX recovered clock according to the RX data D_RX and output the RX recovered clock as the common clock CLK_C. Any CDR technique capable of deriving the RX recovered clock from the RX data D_RX may be employed by the CDR circuit 210. After the RX recovered clock is available, the noise reduction circuit 206 may apply noise reduction to the RX data D_RX according to the TX data D_TX and the RX recovered clock (e.g., common clock CLK_C). For example, the noise reduction circuit 206 may be a near-end crosstalk cancellation circuit (labeled by “NC”) 212 that is arranged to apply near-end crosstalk cancellation to the RX data D_RX for reducing or mitigating the transmitter induced near-end crosstalk in the RX data D_RX.

The TX clock CLK_TX is intentionally constrained to be in sync with the RX clock CLK_RX for allowing near-end crosstalk cancellation at the near-end crosstalk cancellation circuit 212. In this embodiment, the RX circuit 204 may include an RX front-end circuit (labeled by “RXFE”) 214 and an analog-to-digital converter circuit (labeled by “ADC”) 216; and the TX circuit 202 may include a digital-to-analog converter circuit (labeled by “DAC”) 218 and a TX driver circuit (labeled by “TX driver”) 220. The RX front-end circuit 214 is arranged to receive the input data D_IN. The analog-to-digital converter circuit 216 is arranged to apply analog-to-digital conversion to the input data D_IN according to the RX clock CLK_RX that is set by the RX recovered clock (e.g., common clock CLK_C). That is, the analog-to-digital converter circuit 216 is arranged to convert the input data D_IN into the RX data D_RX according to the RX clock CLK_RX that is set by the RX recovered clock (e.g., common clock CLK_C). The digital-to-analog converter circuit 218 is arranged to apply digital-to-analog conversion to the TX data D_TX according to the TX clock CLK_TX that is set by the RX recovered clock (e.g., common clock CLK_C). That is, the digital-to-analog converter circuit 218 is arranged to convert the TX data D_TX into the output data D_OUT according to the TX clock CLK_TX that is set by the RX recovered clock (e.g., common clock CLK_C). The TX driver circuit 220 is arranged to transmit the output data D_OUT. Since the TX clock CLK_TX is in sync with the RX clock CLK_RX (i.e., TX clock CLK_TX and RX clock CLK_RX have the same frequency and phase), near-end crosstalk induced by the TX circuit 202 can be successfully estimated at the near-end crosstalk cancellation circuit 212, and can be mitigated/cancelled from the RX data D_RX obtained by the RX circuit 204, which allows the input data D_IN to be transmitted from a link partner to a network device (which uses the proposed 100BASE-TX transceiver 200) over a longer distance without the need of repeaters.

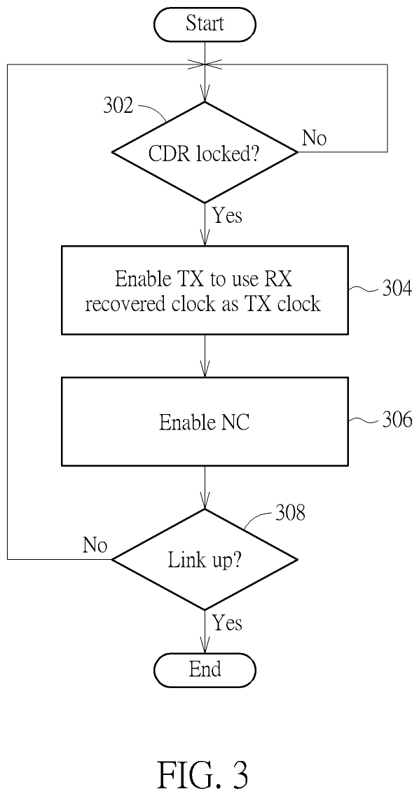

FIG. 3 is a flowchart illustrating a 100BASE-TX transceiving method according to an embodiment of the present invention. The 100BASE-TX transceiving method may be employed by the 100BASE-TX transceiver 100/200. Provided that the result is substantially the same, the steps are not required to be executed in the exact order shown in FIG. 3. At step 302, it is checked to determine if an RX recovered clock is locked by the CDR circuit 210. If yes, the flow proceeds with step 304. If no, the flow returns to step 302. At step 304, the TX circuit 202 is enabled to use the RX recovered clock as its TX clock CLK_TX. At step 306, the near-end crosstalk cancellation circuit 212 enables near-end crosstalk cancellation for generating and outputting the noise-reduced RX data D_RX′. At step 308, it is checked to determine if link up at 100BASE-TX with the link partner is successful. If yes, the flow ends. If no, the flow returns to step 302. Since a person skilled in the pertinent art can readily understand details of the steps after reading above paragraphs directed to the 100BASE-TX transceiver 100/200, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A 100BASE-TX transceiver comprising:
a receive (RX) circuit, arranged to receive an input data according to an RX clock, to generate an RX data;
a transmit (TX) circuit, arranged to transmit a TX data according to a TX clock, to generate an output data, wherein the TX clock is constrained to be in sync with the RX clock; and
a noise reduction circuit, arranged to apply noise reduction to the RX data according to the TX data, to generate a noise-reduced RX data.

2. The 100BASE-TX transceiver of claim 1, wherein the noise reduction circuit is a near-end crosstalk cancellation circuit, and the noise reduction is near-end crosstalk cancellation.

3. The 100BASE-TX transceiver of claim 1, further comprising:
a clock generator circuit, arranged to generate a common clock, wherein both of the RX clock and the TX clock are set by the same common clock.

4. The 100BASE-TX transceiver of claim 3, wherein the clock generator circuit is a clock and data recovery (CDR) circuit, arranged to generate an RX recovered clock according to the RX data and output the RX recovered clock as the common clock.

5. The 100BASE-TX transceiver of claim 4, wherein the noise reduction circuit is arranged to apply the noise reduction to the RX data according to the TX data and the RX recovered clock.

6. The 100BASE-TX transceiver of claim 1, wherein the RX circuit comprises:
an RX front-end circuit, arranged to receive the input data; and
an analog-to-digital converter (ADC) circuit, arranged to convert the input data into the RX data according to the RX clock.

7. The 100BASE-TX transceiver of claim 1, wherein the TX circuit comprises:
a digital-to-analog converter (DAC) circuit, arranged to convert the TX data into the output data according to the TX clock; and
a TX driver circuit, arranged to transmit the output data.

8. A 100BASE-TX transceiving method comprising:
receiving an input data according to a receive (RX) clock, to generate an RX data;
transmitting a transmit (TX) data according to a TX clock, to generate an output data, wherein the TX clock is constrained to be in sync with the RX clock; and
applying noise reduction to the RX data according to the TX data, to generate a noise-reduced RX data.

9. The 100BASE-TX transceiving method of claim 8, wherein the noise reduction is near-end crosstalk cancellation.

10. The 100BASE-TX transceiving method of claim 8, further comprising:
generating a common clock; and
setting both of the RX clock and the TX clock by the same common clock.

11. The 100BASE-TX transceiving method of claim 10, wherein generating the common clock comprises:
performing clock and data recovery (CDR) to generate an RX recovered clock according to the RX data; and
outputting the RX recovered clock as the common clock.

12. The 100BASE-TX transceiving method of claim 11, wherein the noise reduction is applied to the RX data according to the TX data and the RX recovered clock.

13. The 100BASE-TX transceiving method of claim 8, wherein receiving the input data according to the RX clock comprises:
performing analog-to-digital conversion to convert the input data into the RX data according to the RX clock.

14. The 100BASE-TX transceiving method of claim 8, wherein transmitting the TX data according to the TX clock comprises:
performing digital-to-analog conversion to convert the TX data into the output data according to the TX clock.
